(19) United States
(12) Patent Application Publication
(10) Pub. No.: US 2016/0321337 A1
(43) Pub. Date: Nov. 3, 2016

(54) USER WORK ATTRIBUTE SURFACING CONTROL

(71) Applicant: Microsoft Technology Licensing, LLC, Redmond, WA (US)

(72) Inventors: Welly Sugiarto Lee, Redmond, WA (US); Paula A. Wing, Sammamish, WA (US); Dmitriy Meyerzon, Bellevue, WA (US); Karl Thompson, Redmond, WA (US)

(21) Appl. No.: 14/828,968

(22) Filed: Aug. 18, 2015

Related U.S. Application Data
(60) Provisional application No. 62/155,180, filed on Apr. 30, 2015.

(51) Int. Cl. G06F 17/30; G06F 3/0484; G06F 3/0482; G06T 11/20

(52) U.S. Cl. CPC G06F 17/30572; G06T 11/206; G06F 3/04842; G06F 3/0482; G06F 17/30958; G06F 17/30601; G06F 17/30554

(57) ABSTRACT

A computing system comprises, in one example, a display system, an organization graph component configured to access an organization graph that represents users of an organization as nodes and connections between the nodes represent relationships between the users, an aggregate data surfacing system comprising an aggregation component configured to identify a given user and to aggregate user data, from a plurality of users, based on a relationship of the plurality of users to the given user in the organization graph, and a display system controller configured to control the display system to generate an aggregate data user interface display that visualizes at least a portion of the organization graph and displays a user interface element that represents the aggregated user data.

### CROSS-REFERENCE TO RELATED APPLICATION

The present application is based on and claims the benefit of U.S. provisional patent application Ser. No. 62/155,180, filed Apr. 30, 2015, the content of which is hereby incorporated by reference in its entirety.

### BACKGROUND

Organizations typically include users that perform various tasks and activities in fulfillment of organizational operations. For example, a service industry or project-based organization has projects that are broken down into activities. Each activity needs to be performed in order to complete the project.

Often, users within the organization desire to find work attributes or other work-related information for people within the organization. For example, a user may be looking for someone in the organization that has a particular work experience (e.g., current and/or past projects or other work). For instance, the user may desire to find an expert within a particular area.

The discussion above is merely provided for general background information and is not intended to be used as an aid in determining the scope of the claimed subject matter.

### SUMMARY

A computing system comprises, in one example, a display system, an organization graph component configured to access an organization graph that represents users of an organization as nodes and connections between the nodes represent relationships between the users, an aggregate data surfacing system comprising an aggregation component configured to identify a given user and to aggregate user data, from a plurality of users, based on a relationship of the plurality of users to the given user in the organization graph, and a display system controller configured to control the display system to generate an aggregate data user interface display that visualizes at least a portion of the organization graph and displays a user interface element that represents the aggregated user data.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a user work attribute surfacing architecture.

FIGS. 2-1 and 2-2 (collectively referred to as FIG. 2) illustrate a flow diagram of one example of a method for surfacing aggregate work attribute data.

FIG. 3 illustrates a portion of an organization graph, in one example.

FIG. 4 illustrates one example of an aggregate user data display.

FIG. 5 illustrates one example of a user interface that displays filtered data.

FIG. 6 is a flow diagram of one example of a method for obtaining aggregate user data.

FIG. 7 is a flow diagram of one example of a method for pre-processing aggregate data.

FIG. 8 is a block diagram showing one example of the architecture illustrated in FIG. 1, deployed in a cloud computing architecture.

FIG. 9-11 show various examples of mobile devices that can be used with the architecture shown in FIG. 1.

FIG. 12 is a block diagram of one example computing environment.

### DETAILED DESCRIPTION

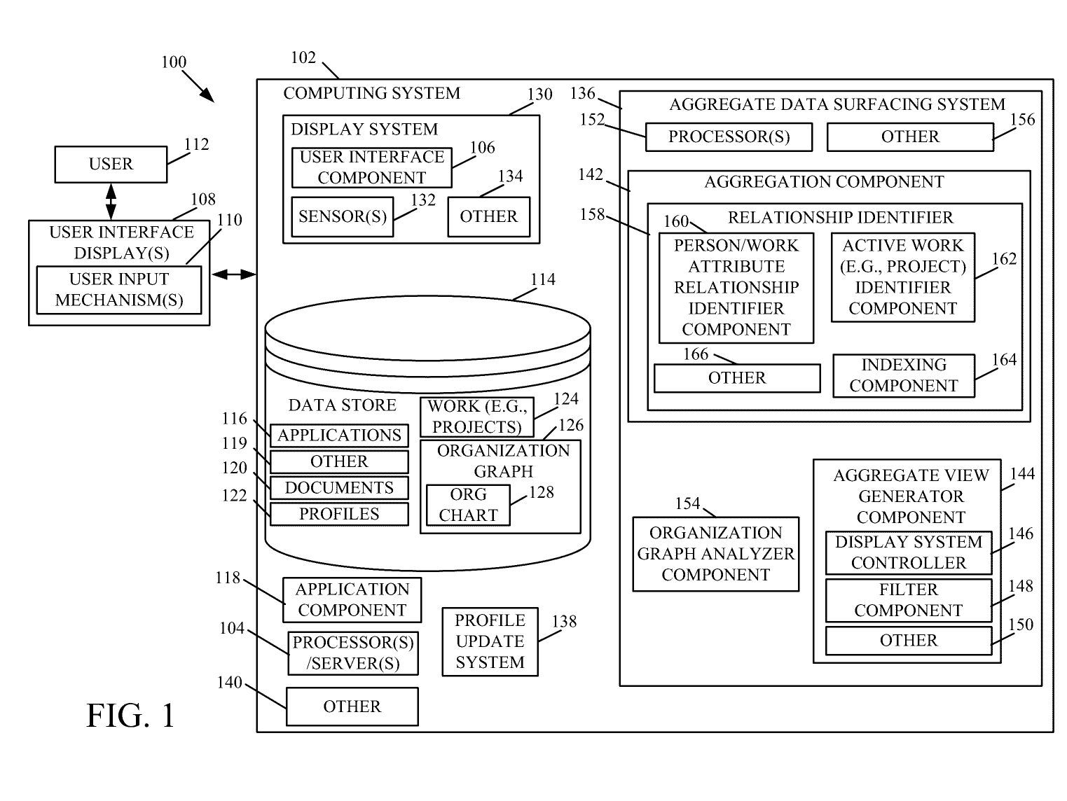

FIG. 1 is a block diagram of one example of a user data surfacing architecture 100. Architecture 100 includes a computing system 102 that is accessible by one or more users through one or more user interface displays. A user interface component 106 generates user interface display(s) 108 with user input mechanisms 110, for interaction by a user 112. In FIG. 1, a single user 112 is illustrated interacting with computing system 102, for sake of illustration. However, in other examples, any number of users may interact with computing system 102.

It is noted that examples of architecture 100 are herein described in the context of surfacing work attributes for the sake of illustration, but not by limitation. Architecture 100 can surface other types of user data alternatively or in addition to work attributes.

User 112 can access computing system 102 locally or remotely. In one example, user 112 uses a client device that communicates with computing system 102 over a wide area network, such as the Internet. User 112 interacts with user input mechanisms 110 in order to control and manipulate computing system 102. For example, using user input mechanisms 110, user 112 can access data in a data store 114.

User input mechanisms 110 sense physical activities, for example by generating user interface display(s) 108 that are used to sense user interaction with computing system 102. The user interface display(s) 108 can include user input mechanism(s) 110 that sense user input in a wide variety of different ways, such as point and click devices (e.g., a computer mouse or track ball), a keyboard (either virtual or hardware), and/or a keypad. Where the display device used to display the user interface display(s) 108 is a touch sensitive display, the inputs can be provided as touch gestures. Similarly, the user inputs can illustratively be provided by voice inputs or other natural user interface input mechanisms as well.

Computing system 102 can be any type of system accessed by user 112. In one example, but not by limitation, computing system 102 comprises an electronic mail (e-mail) system, a collaboration system, a document sharing system, a scheduling system, and/or an enterprise system. In one example, computing system 102 comprises a business system, such as an enterprise resource planning (ERP) system, a customer resource management (CRM) system, a line-of-business system, or another business system.

As such, computing system 102 includes applications 116 that can be any of a variety of different application types. Applications 116 are executed using an application component 118 that facilitates functionality within computing system 102. By way of example, application component 118 can access information in data store 114. For example, data store 114 can store data and metadata. The data and metadata can define workflows, processes, entities, and a wide variety of other information 119. Application component 118 accesses the information in data store 114 in implementing programs, workflows, or other operations performed by application component 118.

By way of example, the entities stored in data store 114 can comprise or represent documents 120, user profiles 122, and/or work 124 within an enterprise, or other organization, in which computing system 102 is deployed.

In one example, a document comprises a collection of information, including but not limited to text, in any of a variety of different formats. Examples of documents include, but are not limited to, word processing documents, spreadsheet documents, slideshow or multimedia presentation documents, html documents, forms, notebooks, emails, meeting documents, and scheduling application documents, to name a few. Further, work 124 includes, but is not limited to, activities, jobs, tasks, topics, projects, and/or any other opportunity for a user.

Data store 114 also stores an organization graph 126, such as an organization chart (or “org chart”) 128 or other type of data structure that relates users within an organization. For example, organization graph 126 defines relationships between users, such as users that frequently meet or communicate (e.g., email) with each other.

As used herein, a “user” can be a member or person who interacts with architecture 100 (e.g., user 112) as well as a person who does not interact with architecture 100. For example, users can include any people within or associated with an organization for which work attributes and/or other information are stored, such as in profiles 122, for surfacing by architecture 100. A profile comprises, in one example, user data and/or metadata which defines user attributes, such as, but not limited to, work attributes of a given user. In one example, the profile stores keywords or other information which define the user's expertise, skills, experience, behavior, personal preferences and characteristics, etc. In one example, a user profile 122 comprises a resume created and/or maintained by the user.

Organizational graph 126 comprises multiple nodes associated with people of an organization, and connections between the nodes representing relationships between the nodes. Organizational graph 126 can thus represent people and their roles within an organization, as well as connections or relationships between those people. The relationships can be any of a variety of different types. For example, organization chart 128 can define a flat (or horizontal) organization structure, a matrix organization structure, and/or a hierarchical organization structure.

For the sake of the present discussion, but not by limitation, embodiments will be described in the context of a hierarchical organization graph in which nodes are arranged in hierarchical parent/child relationships (e.g., a tree structure), where a parent node has one or more child nodes that depend therefrom, and each child node depends from at least one parent node.

In one example, a node in organization graph 126 can represent a particular user (e.g., user 112) within the organization, such as a member or employee. In this manner, organization graph 126 indicates relationships between individual people. Alternatively, or in addition, a node in organization graph 126 can represent a position in the organization (e.g., a particular director position, sales person, engineer, etc.) or a user group (e.g., a sales team, etc.).

Further, the organization graph 126 can be defined along any of a variety of organizational criteria. For example, organization graph 126 can represent the hierarchy of an organization's users in terms of position or rank (e.g., relationships of managers and sub-workers who make up an organization). Alternatively, or in addition, organization graph 126 can represent the hierarchy of an organization's members in terms of reporting relationships between people (e.g., a member's direct reports are child nodes). Also, organization graph 126 can show employee details, chains of command, departmental responsibility, and/or employee group alignment, for example.

In the example shown in FIG. 1, computing system 102 illustratively includes processor(s) and/or server(s) 104, a display system 130 (which, itself, includes user interface component 106 and one or more sensors 132, and it can include other items 134 as well), an aggregate data surfacing system 136, and a profile update system 138 configured to update profiles 122 (e.g., automatically and/or in response to user input). Sensor(s) 132 are configured to detect inputs to display system 130. In one example, systems 136 and 138 also include sensors configured to detect inputs to those systems. Computing system 102 can include other items 140 as well.

In one example, processor(s)/server(s) 104 comprises at least one computer processor with associated memory and timing circuitry (not shown). The computer processor is illustratively a functional part of system 102 and is activated by, and facilitates the functionality of, other systems, components and items in computing system 102.

FIG. 1 shows a variety of different functional blocks. It will be noted that the blocks can be consolidated so that more functionality is performed by each block, or they can be divided so that they functionality is further distributed. It should also be noted that data store 114 can be any of a wide variety of different types of data stores. Further, data store 114 can be stored in multiple data stores. Also, the data stores can be local to the environments, agents, modules, and/or components that access them, or they can be remote therefrom and accessible by those environments, agents, modules, and/or components. Similarly, some can be local while others are remote.

By way of example, computing system 102 may be utilized by an organization that performs various work (e.g., work 124) in fulfillment of organizational operations. For instance, a user within a service industry or project-based organization may perform work either individually, or as part of a team or collection of workers.

Further, by way of example, a user (e.g., user 112) within the organization may desire to find work attributes or other work-related information for other users. Work attributes can pertain to current or past work being performed by a user and include, but are not limited to, user skills, experience, certifications, education, project(s) that the user has or is working on, and/or topic or subject matter areas in which the user is working or has worked. For instance, user 112 may desire to find other user(s) in the organization that have a particular set of knowledge, skills, and/or competencies. For example, user 112 may desire to find other user(s) in the organization that have a particular work connection or experience (e.g., current and/or past projects or other work) and/or may be considered an expert within a particular area.

One source of work attributes or other work-related information is profile information stored in profiles 122. In one example, each user (which can be a person that interacts with architecture 100 or a person who does not interact with architecture 100) has a corresponding profile 122.

Further, when a person, such as user 112, desires to lookup or access data relative to a particular person in an organization, organization graph 126 can provide additional context on who the person is and what they do within the organization. However, the useful information available in many scenarios is often limited, and may not be of much use to the user. For example, some organization structures, such as flat and matrix organization structures, provide some information on relationships between users but may not be dynamic enough to accurately and adequately describe the organization. It can be difficult for a user to surface information regarding other users, in a meaningful way, using these organization structures.

In the illustrated example, aggregate data surfacing system 136 includes an aggregation component 142, an aggregate view generator component 144, one or more processors 152, and an organization graph analyzer component 154. System 136 can include other items 156 as well.

System 136 is configured to aggregate and surface data pertaining to users, such as but not limited to user profile information from profiles 122. The data can include work attributes, such as the skills of the user's group membership information and information on projects that the users are currently working on (i.e., “active” work). In the illustrated example, aggregation component 142 aggregates the data and conflates the organization graph 126 with the aggregated data. In one example, which is discussed in further detail below, aggregation component 142 is configured to, for a given user in organization graph 126, aggregate data for a plurality of other users that are related to the user through graph 126. Aggregate view generator component 144 is configured to generate various views of this aggregated data. Component 144 includes a display system controller 146 that is configured to control display system 130 and user interface component 106 to generate user interface displays (e.g., displays 108). Component 144 includes a filter component 148, and can include other items 150 as well.

Aggregation component 142 includes a relationship identifier 158 that includes a person/work attribute relationship identifier component 160, an active work identifier component 162, an indexing component 164, and can include other items 166 as well.

Component 160 is configured to identify relationships between users and work attributes. For example, component 160 can be configured to identify an association between a given skill or project and user 112. Active work identifier component 162 is configured to identify work that is considered active. In one example, determining whether a particular unit of work (such as a particular project, activity, and/or task) is active is based on user activity relative to that work. For instance, a project is considered active if a user has recently performed some action relative to the project. This can include, but is not limited to, creating, updating, or deleting documents 120 that refer to or are otherwise associated with the project.

In one particular example, active work identifier component 162 identifies that user 112 recently (e.g., within a predefined threshold time period) sent an email or scheduled a meeting with respect to a particular project. As such, with respect to user 112, the project is considered active. Further, this same project can be considered inactive for another user, for example if the other user has not performed any activity on the project within the threshold time period (e.g., the last week, month, year, or some other time period). Also, in one example, the list of active projects are ranked according to recency and volume of activity of the user on that project, for example using an exponential decay on the activity count.

Indexing component 164 is configured to build an index, which can be stored in data store 114 for example, for the data aggregated by aggregation component 142. This is discussed in further detail below.

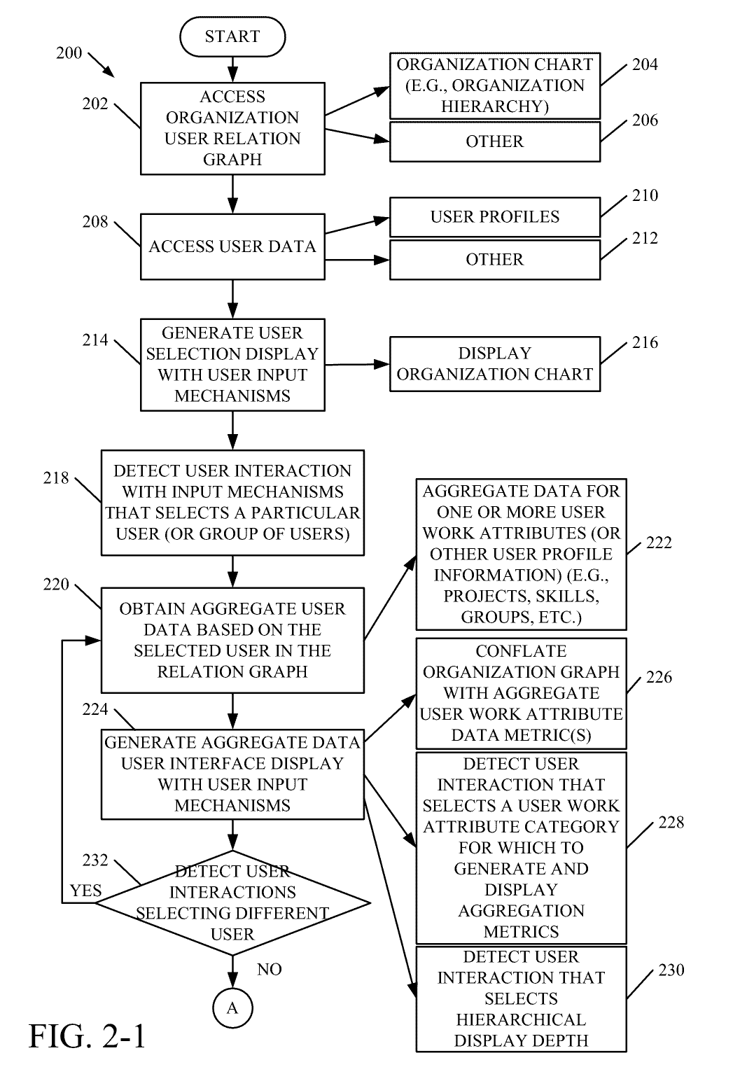

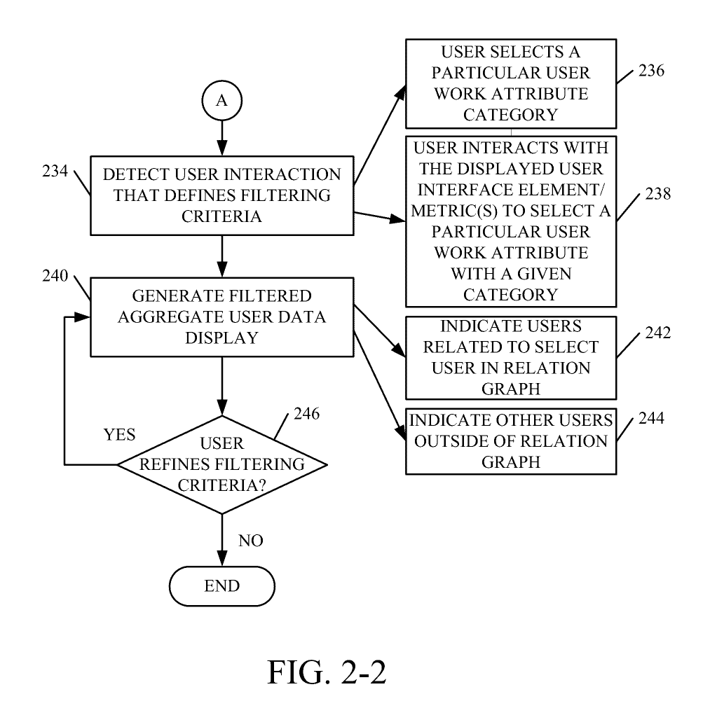

FIGS. 2-1 and 2-2 (collectively referred to as FIG. 2) illustrate a flow diagram of one example of a method 200 for surfacing aggregate work attribute data. For the sake of illustration, but not by limitation, method 200 will be described in the context of system 136 surfacing data to user 112 through user interface displays 108.

At step 202, organization graph analyzer component 154 accesses organization graph 126 to identify a relationship between users. In the illustrated example, the organization graph comprises a hierarchical organization chart that defines a user hierarchy within an organization. This is represented by block 204. Of course, user relationships can be identified in other ways as well. This is indicated by block 206.

At step 208, aggregation component 142 accesses user data for a plurality of users. For example, the user data comprises user work attribute data that is accessed through user profiles 122. This is represented by block 210. Of course, user data can be accessed in other ways as well. This is indicated by block 212.

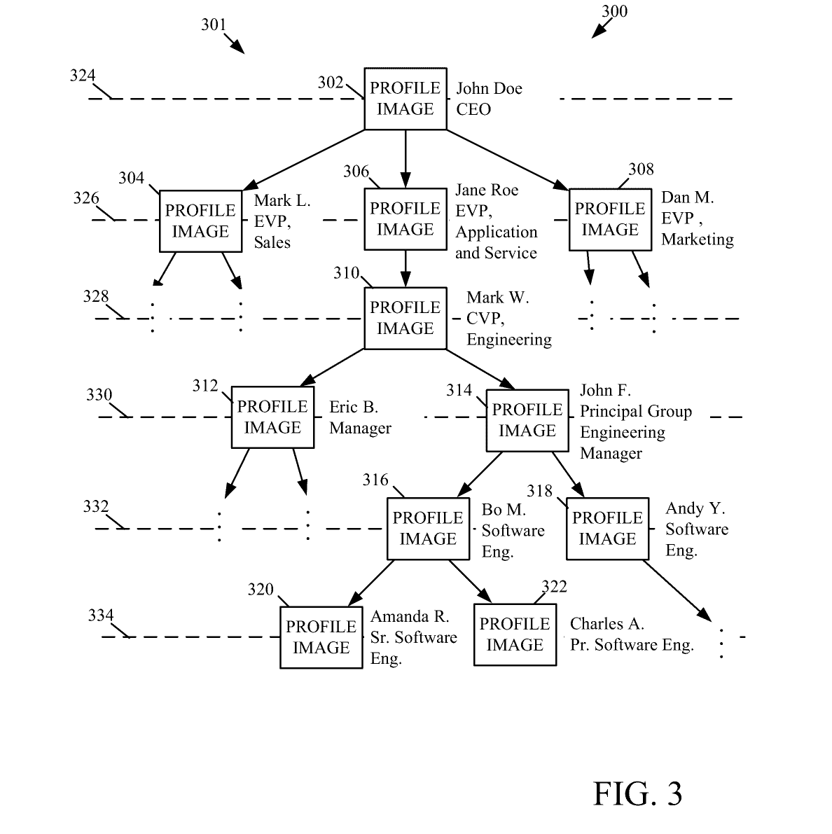

At step 214, a user selection display is generated with user input mechanisms. The user selection display facilitates selection of one or more users for which to display aggregated work attributes or other work related data. In one example, the user selection display displays the organization graph with each user represented as a user selectable element. This is represented by block 216. One example of a user selection display 300 is illustrated in FIG. 3.

In the example of FIG. 3, user selection display 300 displays a portion of an organization graph, in the form of a hierarchical organization chart 301 having a plurality of nodes arranged in a plurality of hierarchical levels 324, 326, 328, 330, 332, and 334, where connections between the nodes represent relationships between the nodes. The nodes are arranged in hierarchical parent/child relationships, where a parent node has one or more child nodes that depend therefrom, and each child node depends from at least one parent node. Level 324 illustratively comprises a root level and level 334 comprises a bottom or lowermost leaf level.

User selection display 300 displays a plurality of user interface elements 302-322 that each identify a corresponding user in the organization graph. Each element 302-322 is illustrated as displaying a user name and a user role or position. Of course, each element can display additional information for the user as well. Further, in one example, one or more of the elements 302-322 can represent a group of users, such as a team or other group.

Referring again to FIG. 2, at step 218 a user interaction is detected that selects a particular user (or group of users) from the user selection display. In response to the selection, additional information pertaining to the selected user or group of users can be displayed. For instance, contact information for the selected user can be display. In the example of FIG. 3, the user interaction at step 218 actuates one of the user interface elements 302-322 to select a corresponding user.

At step 220, aggregated user data is obtained based on the selected user(s). For example, at step 222, user work attribute data can be aggregated for one or more work attribute types or categories (e.g., projects, skills, and/or groups, etc.). Other user profile information can be aggregated as well.

At step 224, an aggregate data user interface display is generated with user input mechanisms. At step 226, for a given work attribute category (e.g., projects), the organization graph accessed at step 202 is conflated with the aggregate user work attribute data. In one example, a user interface element is generated with a plurality of aggregation metrics, each aggregation metric visually representing one of the user work attributes (e.g., particular projects associated with users) in the given category.

In an example where data is aggregated for a plurality of different work attribute categories (e.g., skills and projects), at step 228 a user interaction is detected that selects one or more particular work attribute categories for which to generate and display aggregation metrics. For example, from step 222, both project and skills attributes can be aggregated from a plurality of users. As such, at step 228, the user can select whether a user interface element with aggregation metrics is displayed for either or both of the attribute categories.

In one example, at step 230, a user interaction is detected that selects a hierarchical display depth. The hierarchical display depth determines a depth into the organization graph for which to display the aggregated data. This is discussed in further detail below.

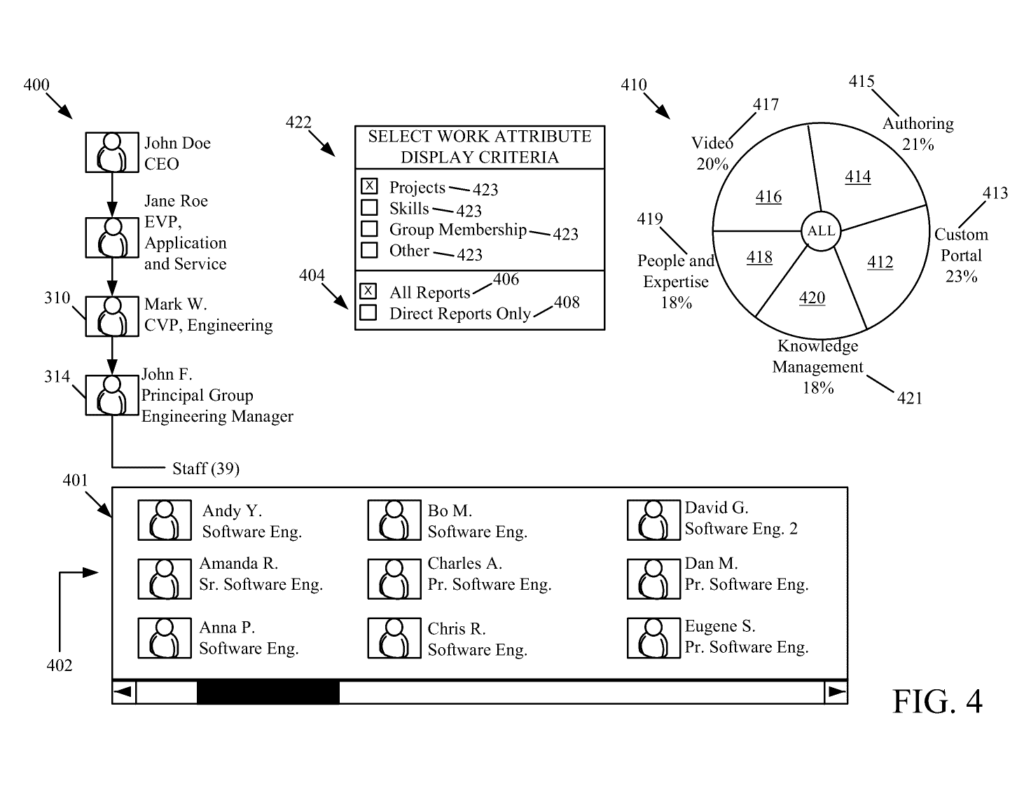

FIG. 4 illustrates one example of an aggregate user data display 400 generated at step 224. In the illustrated example, display 400 is displayed in response to a user selecting user interface element 314 representing a corresponding user (i.e., “John F”, also referred to as user 314). Display system controller 146 controls user interface component 106 in generating user interface display 400 to represent user 314 based on user 314's relationships with other users in the organization graph. In FIG. 4, user interface 400 shows that user 314 has a dependent relationship from the user represented by user interface element 310 (i.e., “Mark W”, also referred to as user 310). Display 400 includes a display portion 401 that displays a plurality of user interface elements 402 that represent other users (also referred to as users 402) that have a dependent relationship from user 314.

In the illustrated example, the organization graph represented in FIG. 4 is defined along reporting lines. As such, user 314 is a direct report of user 310, and users 402 are direct and/or indirect reports of user 314. In this example, an indirect report of user 314 can be a user who reports to one of user 314's direct reports, but may not directly report to user 314. Similarly, user 314 is a direct report of user 310 and users 402 are indirect reports of user 310. This, of course, is by way of example only. Other types of organization graph can be utilized.

Using a hierarchical display depth user input mechanism 404, the user can select the hierarchical display depth within user interface 400. In the present example, the user can select a first control 406 in which all reports (i.e., direct and indirect reports) for user 314 are displayed or a user input mechanism 408 in which only the direct reports of user 314 are displayed.

User interface 400 includes a user interface element 410 that includes a plurality of aggregation metrics for the selected user (i.e., user 314 in the present example). Each aggregation metric visually represents one of the user work attributes in a given work attribute category (i.e., projects in the present example). In the illustrated example, user interface element 410 comprises a pie chart (or other graphical representation) for the particular work attribute category that has been aggregated over users associated with the selected user.

In this example in which project information has been aggregated, user interface element 410 shows a plurality of aggregation metrics 413, 415, 417, 419, and 421 that represent projects for which users 402. More specifically, it shows that twenty three percent of users 402 are working on a “custom portal” project (i.e., metric 413), twenty one percent of users 402 are working on an “authoring” project (i.e., metric 415), twenty percent of users 402 are working on a “video” project (i.e., metric 417), eighteen percent of users 402 are working on a “people and expertise” project (i.e. metric 419), and eighteen percent of users 402 knowledge management project (i.e., metric 421). While metrics 413-421 are shown in terms of percentages, other types of metrics can be utilized. For example, metrics 413-421 can indicate a total number of users that are working on each project. These, of course, are examples only.

Further, in the illustrated example, each metric 413, 415, 417, 419, and 421 comprises a corresponding user input mechanism or control element 412, 414, 416, 418, and 420, that is actuatable to implement a corresponding filter. This is discussed in further detail below. Briefly, however, in FIG. 4 each control element 412, 414, 416, 418, and 420 is actuatable to filter the aggregated data based on the corresponding project attribute.

Further, in the illustrated example, interface 400 also includes a user input mechanism 422 having control(s) 423 that allows the user to select which work attribute categories for which to display aggregated data. For example, the user can select one or more different work attribute categories for which to surface aggregate data. In FIG. 4, control 423 corresponding to the project attribute category has been selected. Of course, multiple controls 423 can be selected to display multiple user interface elements, with each element having metrics that represent the corresponding work attribute category. Further, user input mechanism 422 can also include a control element that allows the user to define the display type for the user interface element(s) and corresponding metrics, such as whether the element(s) is/are displayed as a pie chart, bar chart, graph, table, etc.

FIG. 4, of course, is by way of example only. Work attributes can be aggregated and displayed in any of a number of ways.

Referring again to FIG. 2, at step 232, the user can select a different user in user interface 400 for which to surface data. For example, the user can select a user interface element corresponding to one of users 402, upon which user interface 400 can display additional profile data (or other data) for that user and/or aggregated data from related users in the organization graph. If a different user is selected at step 232, the method returns to step 220 upon which aggregate user data is obtained and displayed in the user interface.

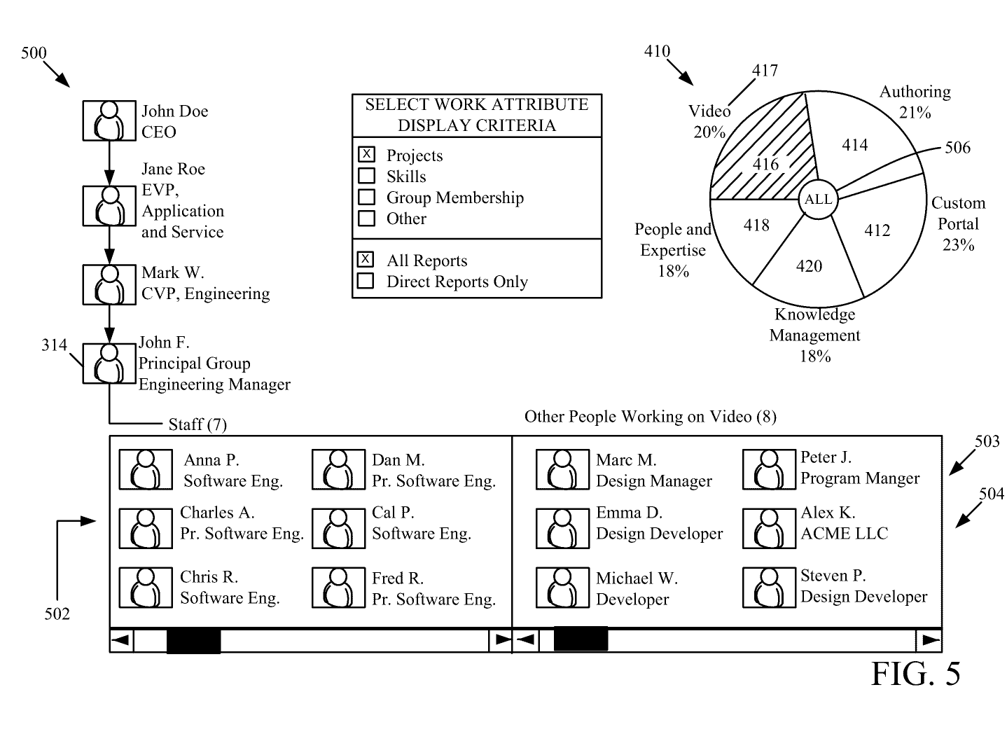

At step 234, the user can define filtering criteria for filtering the aggregate data that is displayed in the user interface. In one example, the user can select a particular work attribute category at step 236. In another example, at step 238 the user interacts with the user interface element to select a particular work attribute as filter criteria (e.g., by actuating one of control elements 412-420). At step 240, a filtered aggregate user data display is generated. FIG. 5 illustrates one example of a user interface display 500 that displays filtered data.

As shown in FIG. 5, the user has selected the control element 417 corresponding to the “video” project. In response, user interface display 500 displays a plurality of user interface elements that represent users that are working on the selected video project. In the illustrated example, in a first display portion 501, a plurality of user interface elements 502 represent a subset of users 402 that are associated with selected user 314 in the organization graph. In other words, display portion 501 represents only those users 402 that are working on the selected video project. This is indicated at block 242 in FIG. 2. Also, in a second display portion 503, a plurality of user interface elements 504 represent other users that are working on the selected video project, but are not associated with the selected user 314 in the organization graph (e.g., they are not direct or indirect reports of user 314). This is represented at block 244 in FIG. 2.

The user can redefine the filtering criteria by selecting another control element 413-421 of user interface element 410. For example, the user can select control element 413 corresponding to the “custom portal” project. Further, the user can select a control element 506 which removes the filtering criteria by displaying the users for all of the project attributes, for example by returning to the view of user interface display 400. Redefining the filtering criteria is represented at step 246.

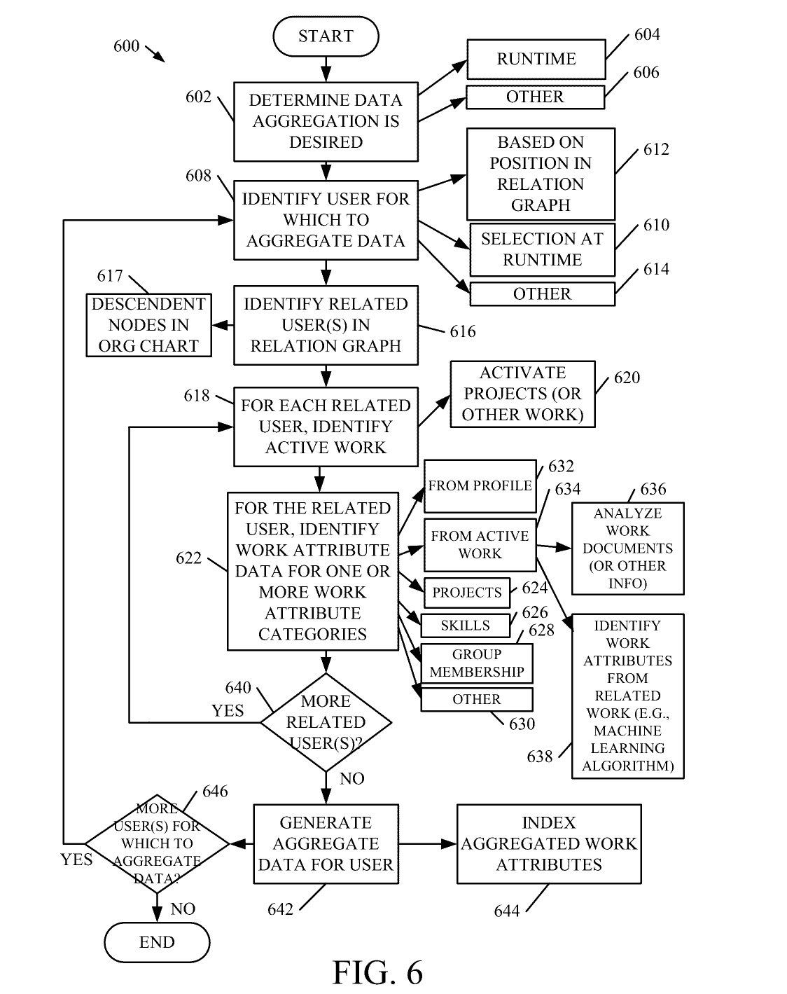

FIG. 6 is a flow diagram of one example of a method 600 for obtaining aggregate user data, which can be used at step 220 in method 200, for example. For sake of illustration, but not by limitation, method 600 will be described in the context of aggregation component 142 aggregating data from data store 114.

At step 602, the method determines that data aggregation is desired. For example, method 600 can be initiated at runtime in response to a user input that requests a display of aggregated data. This is represented by block 604. Alternatively, or in addition, method 600 can be initiated at other times as well. This is represented by block 606. For example, data aggregation can be performed when the surfacing system 136 is offline (e.g., not being used by user 112 at runtime). As such, the aggregate data can be precomputed prior to runtime which can improve the performance of surfacing system 136 by decreasing the time required to surface the aggregate data in response to a user input request.

At step 608, the method identifies a user for which to aggregate data. This can be based on a selection at runtime, which is represented at block 610. For example, a user is identified by selecting user interface element 314 shown in FIG. 3.

Alternatively, or in addition, the user can be identified based on a position of the user in the relation graph. This is represented by block 612. For example, users who are higher in the organization hierarchy are likely to have more users below them in the hierarchy. As such, when method 600 is being performed offline, to precompute the aggregate data, step 608 can select only those user(s) that are proximate (e.g., within a threshold number levels of) the top or root level of the organization graph 126. In another example, a user is select if they have more than a threshold number of dependent nodes below them in the graph 126. In either case, the step 612 can select a subset of the users for which aggregation is likely to be computationally expensive and adversely affect performance of the system if performed at runtime.

Of course, the user can be identified in other ways as well. This is represented by block 614.

At step 616, for the user identified at step 608, related users are identified in the organization graph 126. In one example, this comprises identifying all descendent nodes at step 617 (e.g. users who are at nodes in org chart 128 that are direct descendants from the identified user as well as the descendants of those descendants). For example, if Jane Row, represented by node 306 in FIG. 3, is selected at step 608, step 616 identifies the user 310 as well as users 312 and 314.

At step 618, for each of the related users, the method identifies active work associated with that user. For example, this can include identifying active projects (or other work) at step 620. In determining whether a project is active with respect to a given user, component 162 can determine how often that user's name is mentioned or occurs in documents 120 with respect to the project, in one example.

At step 622, for the related user, work attribute data for one or more work attribute categories is identified. Examples of work attribute data include, but are not limited to, projects 624, skills 626, group memberships 628, or other attribute categories 630. In one example, skills 626 are identified from the active projects (or other work) of the user. Further, skills 626 can be identified by locating other users that have similar characteristics. For instance, another user may have a same or similar job title. In this case, skills 626 can be inferred from the profile of that other user.

In one example, a project task board can be used to visualize user project tasks and their associated statuses. At step 622, projects 624 and/or skills 626 can be identified by accessing the project task board to determine documents that were tagged or pinned by the related user, thus identifying the document as part of the project, or using a known tag that corresponds to the user skill.

This can be done in any of a number of ways. In one example, the work attributes can be identified from the user's profile at step 632. For example, skills 626 can be mined from a resume of the user.

Alternatively, or in addition, the work attribute data can be identified from the active work identified at step 618. This is represented by block 634. In one example, documents 120 (or other information) are parsed and analyzed at step 636 to identify work attribute data associated with the related user. For instance, a set of projects and/or work expertise can be mined from documents 120 and/or from information associated with other users who are close to the user (e.g., close the user in the organization graph, have a same or similar job title, etc.).

Alternatively, or in addition, at step 638, work attribute data can be identified from related work. In one example, a machine learning algorithm can be utilized to identify whether there are any other projects that have the same or similar characteristics to an active project identified at step 618. From this other project, associated skills (or other work attributes) are mined and assigned to the related user.

At step 640, the method determines whether there are any more related users. If so, the method returns to step 618. If not, the method proceeds to step 642 in which the data is aggregated for the identified user from step 608. For example, this can include aggregating all of the work attribute data. In one example, all of the aggregated work attribute data is indexed at step 644.

At step 646, the method determines whether there are any more users for which to aggregate data. If so, the method returns to step 608.

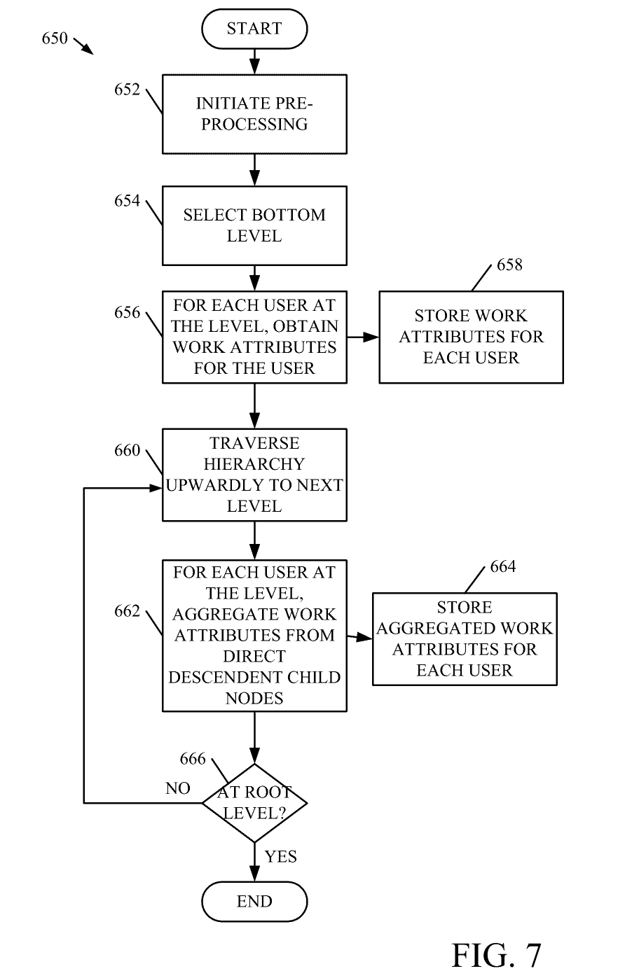

FIG. 7 is a flow diagram of one example of a method 650 for pre-processing aggregate data over an organization hierarchy. By pre-processing, it is meant that the aggregate data is precomputed prior to a runtime request (e.g., a user query) to surface or visualize the aggregate data. As such, the aggregate data can be precomputed prior to runtime which can improve the performance of surfacing system 136 by making the aggregated data readily available to service requests. This can be particularly beneficial where the organization hierarchy is very large. For sake of illustration, but not by limitation, method 650 will be described in the context of aggregation component 142 obtaining aggregate data over hierarchical organization chart 301. Before describing method 650 in detail, a brief overview will be provided.

Method 650 illustratively comprises a process that iterates over an organization hierarchy (e.g., hierarchical organization chart 301), level by level, by traversing the hierarchy upwardly, beginning from the bottom level 334 (or other lower level of the hierarchy (e.g., level 332)). In one example, method 650 comprises a background analytics process that uses a map/reduce system. A map/reduce system illustratively comprises a programming model and an associated implementation for processing and generating large data sets with a parallel, distributed algorithm on a cluster, for example. In one example, the map/reduce system comprises a map procedure that performs filtering and sorting and a reduce procedure that performs a summary operation. The system allows for distributed processing of the map and reduction operations.

In the particular example of FIG. 7, at block 652 aggregate data pre-processing is initiated, for example periodically and/or in response to a user input (or other input). At block 654, the method selects the bottom level 334 (or other lower level) in hierarchical organization chart 301.

At block 656, for each user at the selected level, work attributes are obtained for the user. For example, user work attributes are attained for each of users 320 and 322. These work attributes can be stored for the users at block 658.

At block 660, the hierarchy is traversed upwardly to the next level (i.e., level 332). At block 662, for each user at the level, work attributes are aggregated from direct descendant child nodes. In the example of FIG. 3, block 662 selects user 316 and then aggregates the work attributes from users 320 and 322. Similarly, for user 318, block 662 aggregates work attribute data from any direct descendant child nodes that directly descend from user 318. The aggregated work attributes are stored for each user at the level at block 664.

At block 666, the method determines whether the processing is at the root level (i.e., level 324). In other words, block 666 determines whether there are any more ancestor levels in chart 301.

If so, the method returns to block 660 in which the hierarchy is traversed upwardly to the next level (i.e., level 330). Then, for each user at level 330, block 662 aggregates or adds up the aggregated work attribute data from the direct descendant child nodes. In the example of FIG. 3, the work attribute data aggregated for users 316 and 318 is added or otherwise combined to obtain the aggregated work attribute data for user 314. Similarly, aggregated work attribute data is obtained for user 312. This aggregated work attribute data is stored for each user at block 664. The method by continuing to traverse the hierarchy to the root level 324.

It can thus be seen that the present discussion provides significant technical advantages. For example, it provides an architecture that controls user work attribute surfacing in a manner that conflates an organizational graph with aggregate user data. This provides a user with work related information in the context of the organization structure. Further, the architecture, in one example, surfaces aggregated user data without requiring multiple separate information searches. For example, the user does not have to perform multiple profile searches to ultimately infer aggregated characteristics for the user, which would not only be error prone, but computationally expensive and require multiple round trips to the underlying data source.

The present discussion mentions processors and servers. In one example, the processors and servers include computer processors with associated memory and timing circuitry, not separately shown. They are functional parts of the systems or devices to which they belong and are activated by, and facilitate the functionality of the other modules, components and/or items in those systems.

Also, a number of user interface displays have been discussed. They can take a wide variety of different forms and can have a wide variety of different user actuatable input mechanisms disposed thereon. The user actuatable input mechanisms sense user interaction with the computing system. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores are also discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

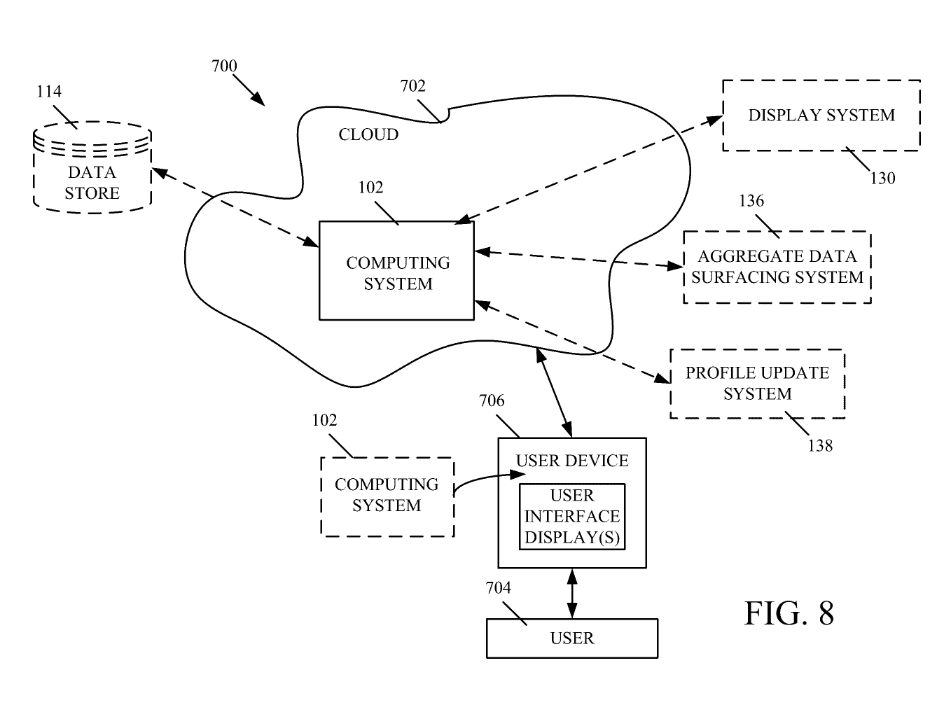

FIG. 8 is a block diagram of architecture 100, shown in FIG. 1, except that its elements are disposed in a cloud computing architecture 700. Cloud computing provides computation, software, data access, and storage services that do not require end-user knowledge of the physical location or configuration of the system that delivers the services. In various examples, cloud computing delivers the services over a wide area network, such as the internet, using appropriate protocols. For instance, cloud computing providers deliver applications over a wide area network and they can be accessed through a web browser or any other computing component. Software, modules, or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the modules, components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 8, some items correspond to those shown in FIG. 1 and they are similarly numbered. FIG. 8 specifically shows that computing system 102 is located in cloud 702 (which can be public, private, or a combination where portions are public while others are private). Therefore, a user 704 (e.g., user 112) uses a user device 706 to access system 102 through cloud 702.

FIG. 8 also depicts another embodiment of a cloud architecture. FIG. 8 shows that it is also contemplated that some components of computing system 102 are disposed in cloud 702 while others are not. In one example, data store 114 can be disposed outside of cloud 702, and accessed through cloud 702. In another example, display system 130 can be disposed outside of cloud 702. In another example, aggregate data surfacing system 136 can be disposed outside of cloud 702. In another example, profile update system 138 can be disposed outside of cloud 702. Regardless of where they are located, system 102 components can be accessed directly by device 706, through a network (either a wide area network or a local area network), they can be hosted at a remote site by a service, or they can be provided as a service through a cloud or accessed by a connection service that resides in the cloud. FIG. 8 also shows that system 102, or parts of it, can be deployed on user device 706. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

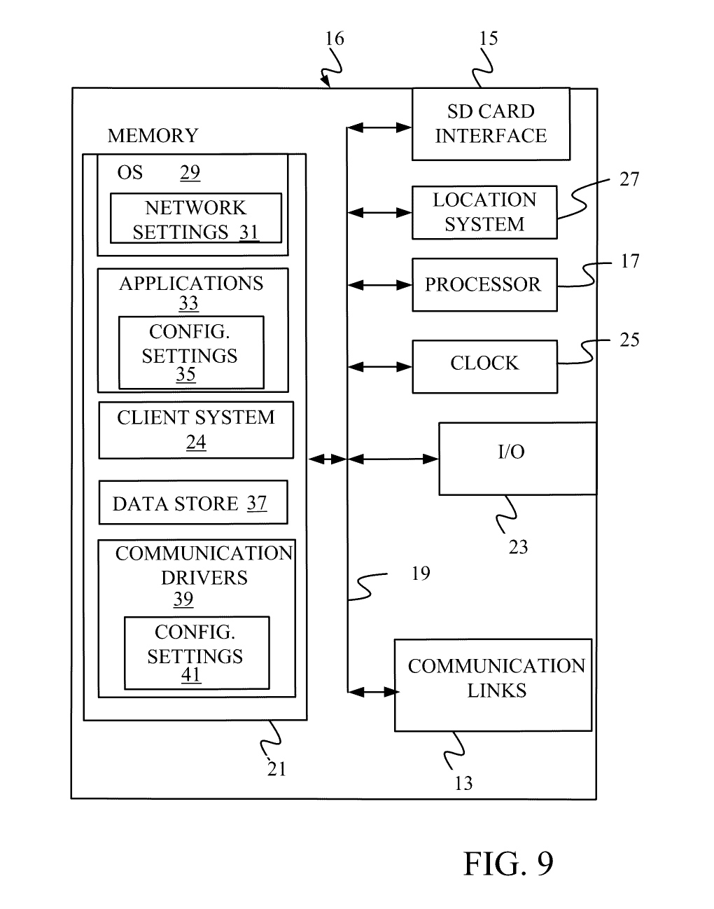

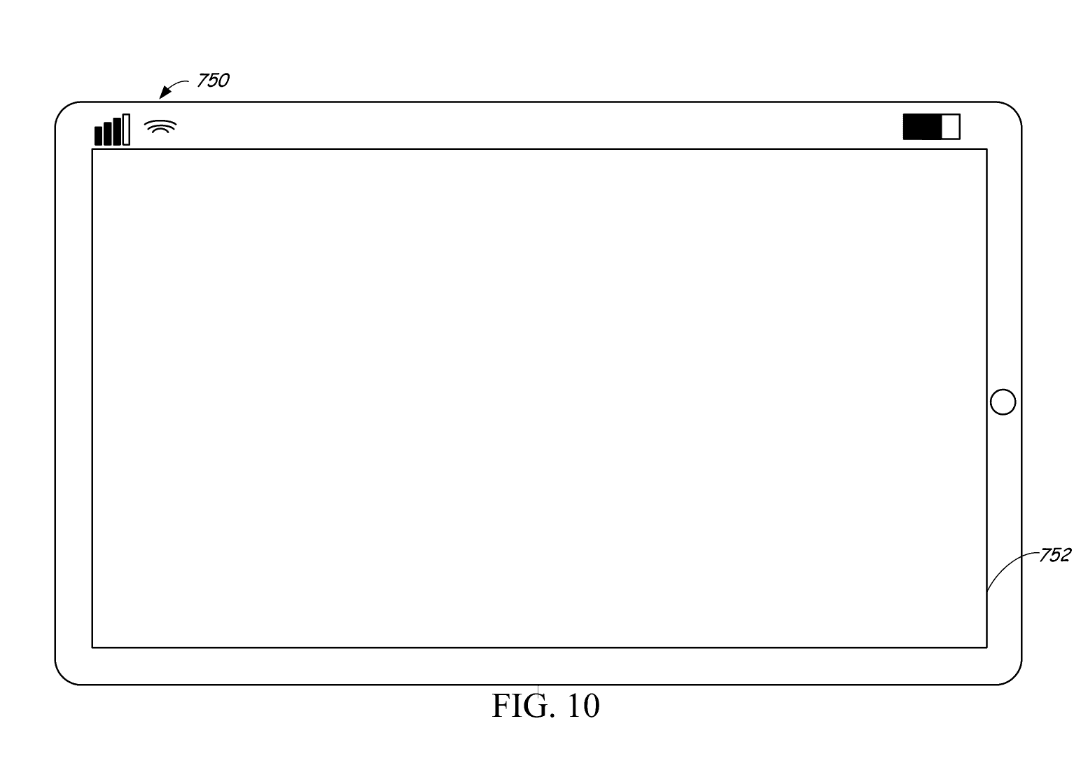

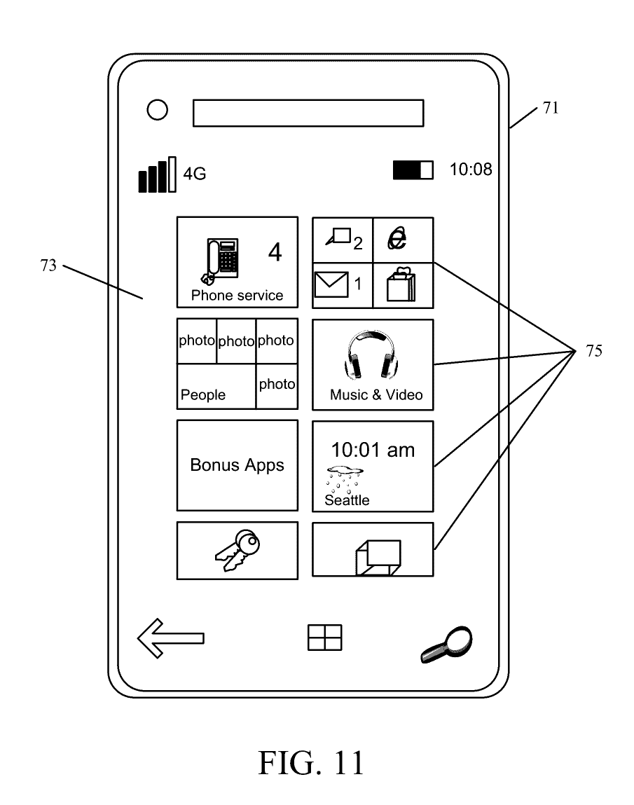

FIG. 9 is a simplified block diagram of one example of a handheld or mobile computing device that can be used as a user's or client's hand held device 16, in which the present system (or parts of it) can be deployed. FIGS. 10-11 are examples of handheld or mobile devices.

FIG. 9 provides a general block diagram of the components of a client device 16 that can run modules or components of architecture 100 or that interacts with architecture 100, or both. In the device 16, a communications link 13 is provided that allows the handheld device to communicate with other computing devices and in some examples provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as 802.11 and 802.11b (Wi-Fi) protocols, and Bluetooth protocol, which provide local wireless connections to networks.

In other examples, applications or systems are received on a removable Secure Digital (SD) card that is connected to a SD card interface 15. SD card interface 15 and communications link 13 communicate with a processor 17 (which can also embody processor(s) 104 from FIG. 1) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 comprises a real time clock component that outputs a time and date. It can also provide timing functions for processor 17.

Location system 27 includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. It can also store a client system 24 which can be part or all of architecture 100. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Processor 17 can be activated by other modules or components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 10 shows one example in which device 16 is a tablet computer 750. In FIG. 10, computer 750 is shown with user interface display screen 752. Screen 752 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 750 can also receive voice inputs as well.

Additional examples of devices 16 can be used as well. Device 16 can be, a feature phone, smart phone or mobile phone. The phone can include a set of keypads for dialing phone numbers, a display capable of displaying images including application images, icons, web pages, photographs, and video, and control buttons for selecting items shown on the display. The phone can include an antenna for receiving cellular phone signals such as General Packet Radio Service (GPRS) and 1×rtt, and Short Message Service (SMS) signals. In some examples the phone also includes a Secure Digital (SD) card slot that accepts a SD card.

The mobile device can also be a personal digital assistant or a multimedia player or a tablet computing device, etc. (hereinafter referred to as a PDA). The PDA can include an inductive screen that senses the position of a stylus (or other pointers, such as a user's finger) when the stylus is positioned over the screen. This allows the user to select, highlight, and move items on the screen as well as draw and write. The PDA can also include a number of user input keys or buttons which allow the user to scroll through menu options or other display options which are displayed on the display, and allow the user to change applications or select user input functions, without contacting the display. The PDA can also include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections.

FIG. 11 shows one example in which device 16 is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

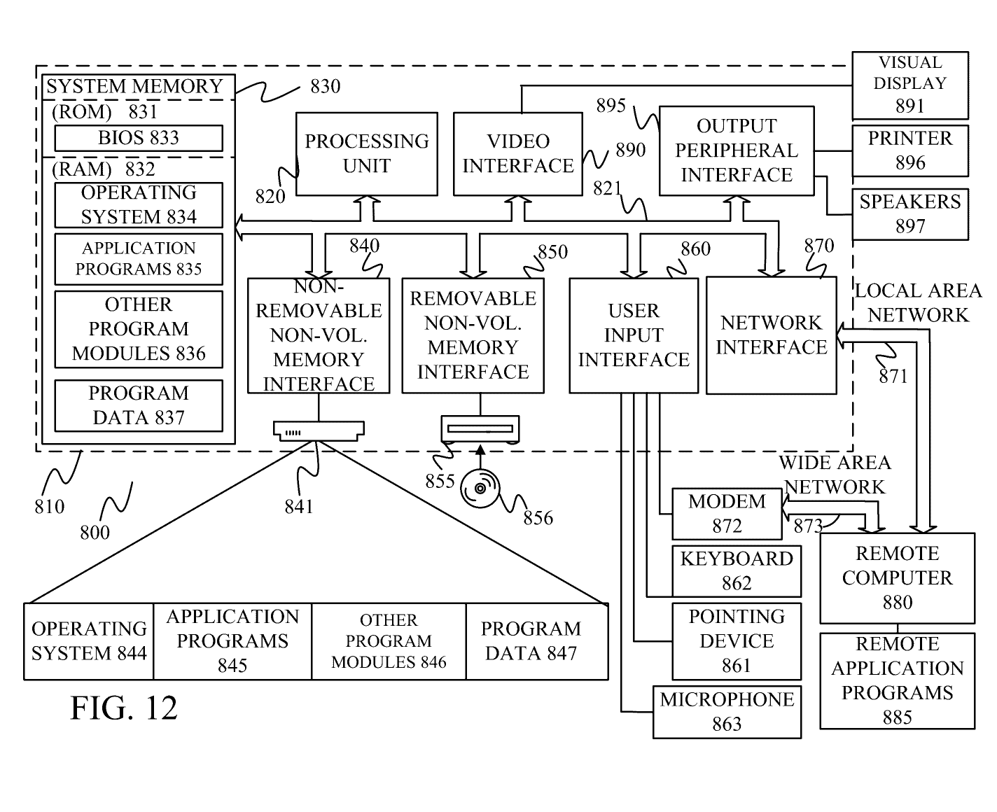

FIG. 12 is one example of a computing environment in which architecture 100, or parts of it, (for example) can be deployed. With reference to FIG. 12, an exemplary system for implementing some examples includes a general-purpose computing device in the form of a computer 810. Components of computer 810 may include, but are not limited to, a processing unit 820 (which can comprise processor(s) 104), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 12.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 12 illustrates operating system 834, application programs 835, other program modules 836, and program data 837.

The computer 810 may also include other removable/non-removable volatile/nonvolatile computer storage media. By way of example only, FIG. 12 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 12, provide storage of computer readable instructions, data structures, program modules and other data for the computer 810. In FIG. 12, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 12 include a local area network (LAN) 871 and a wide area network (WAN) 773, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 12 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing system comprising a display system, an organization graph component configured to access an organization graph that represents users of an organization as nodes and connections between the nodes represent relationships between the users, an aggregate data surfacing system comprising an aggregation component configured to identify a given user and to aggregate user data, from a plurality of users, based on a relationship of the plurality of users to the given user in the organization graph, and a display system controller configured to control the display system to generate an aggregate data user interface display that visualizes at least a portion of the organization graph and displays a user interface element that represents the aggregated user data.

Example 2 is the computing system of any or all previous examples, wherein the aggregation component is configured to obtain the aggregated user data from user profiles corresponding to the plurality of users.

Example 3 is the computing system of any or all previous examples, wherein the user data comprises user work attribute data.

Example 4 is the computing system of any or all previous examples, wherein the aggregation component comprises an active work identifier component configured to identify active work based on activity of the given user relative to the work, wherein the aggregation component aggregates the user work attribute data based on the identified active work.

Example 5 is the computing system of any or all previous examples, wherein the portion of the organization graph visualized in the user interface display comprises the plurality of users, and the user interface display conflates the portion of the organization graph with the aggregated user work attribute data.

Example 6 is the computing system of any or all previous examples, wherein the aggregated user work attribute data comprises a plurality of different work attributes within a particular work attribute category.

Example 7 is the computing system of any or all previous examples, wherein the particular work attribute category comprises at least one of user skills, user work experience, user certifications, user education, projects, or subject matter areas.

Example 8 is the computing system of any or all previous examples, wherein the user interface display includes a user input mechanism configured to detect a user interaction with the user interface display that selects the particular work attribute category from a plurality of work attribute categories.

Example 9 is the computing system of any or all previous examples, wherein the user interface element comprises a plurality of aggregation metrics, each aggregation metric visually representing one of the user work attributes.

Example 10 is the computing system of any or all previous examples, and further comprising a filter component, wherein the user interface element comprises a plurality of user input mechanisms each configured to detect user interaction with the user interface element, each user input mechanism comprising one of the aggregation metrics and being actuatable to select the user work attribute represented by the aggregation metric and to control the display system, using the filter component, to display a subset of the plurality of users based on the selected user work attribute.

Example 11 is the computing system of any or all previous examples, wherein each user input mechanism is actuatable to control the display system to display the subset of the plurality of users, along with a set of users that are identified based on the selected user work attribute and are not identified as being related to the given user in the organization graph.

Example 12 is the computing system of any or all previous examples, wherein the user interface display includes a user input mechanism visually representing a node in the organization graph that corresponds to the given user, the user input mechanism being actuatable to select the given user upon which display of the aggregated data is based.

Example 13 is the computing system of any or all previous examples, wherein the aggregation component is configured to identify the plurality of users, by identifying a first node in the organization graph that corresponds to the given user and identifying descendent nodes in the organization graph, that descend from the first node and correspond to the plurality of users.

Example 14 is the computing system of any or all previous examples, wherein the organization graph comprises a hierarchical organization chart having nodes arranged in a plurality of hierarchical levels, and wherein the aggregation component is configured to precompute the aggregate user data by upwardly traversing the plurality of hierarchical levels.

Example 15 is the computing system of any or all previous examples, wherein the aggregation component comprises an indexing component configured to index, for the given user, the aggregated user data.

Example 16 is the computing system of any or all previous examples, wherein the organization graph comprises a hierarchical organization chart having nodes arranged in hierarchical parent/child relationships, and wherein the aggregate data user interface display includes a hierarchical display depth user input mechanism that receives a user input that indicates a number of levels within the hierarchical organization chart for which to display aggregate user work attributes for the given user.

Example 17 is a computer-implemented method comprising identifying a given user, aggregating user work attribute data, from a plurality of users, based on a relationship of the plurality of users to the given user in an organization graph, the organization graph representing users of an organization as nodes and connections between the nodes represent relationships between the users, and generating an aggregate work attribute user interface display that visualizes at least a portion of the organization graph and displays a user interface element that represents the aggregated user data.

Example 18 is the computer-implemented method of any or all previous examples, wherein the portion of the organization graph visualized in the user interface display comprises the plurality of users, and the aggregated user work attribute data comprises a plurality of different user work attributes within a particular work attribute category, and wherein generating the aggregate work attribute user interface display comprises displaying the user interface element with a set of aggregation metrics, each aggregation metric visually representing one of the user work attributes.

Example 19 is a computing system comprising a display system, an organization graph component configured to access an organization graph that represents users of an organization as nodes and connections between the nodes represent relationships between the users, and a data surfacing system configured to control the display system to generate a user interface display with a user selection user input mechanism and a work attribute selection user input mechanism, detect a user interaction with the user selection user input mechanism that selects a user and a user interaction with the work attribute selection user input mechanism that selects a work attribute, identify a first set of users that are associated with the selected work attribute and are related to the selected user in the organization graph and a second set of users that are associated with the selected work attribute and are not related to the selected user in the organization graph, and control the display system to generate a user interface display element that represents the first and second sets of users.

Example 20 is the computing system of any or all previous examples, wherein the user interface display element visually distinguishes the first and second sets of users, and the work attribute selection user input mechanism visualizes a plurality of aggregation metrics, each aggregation metric visually representing one of a plurality of different user work attributes.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other equivalent features and acts are intended to be within the scope of the claims.

What is claimed is:

1. A computing system comprising:
a display system;
an organization graph component configured to access an organization graph that represents users of an organization as nodes and connections between the nodes represent relationships between the users; and
an aggregate data surfacing system comprising an aggregation component configured to identify a given user and to aggregate user data, from a plurality of users, based on a relationship of the plurality of users to the given user in the organization graph, and a display system controller configured to control the display system to generate an aggregate data user interface display that visualizes at least a portion of the organization graph and displays a user interface element that represents the aggregated user data.

2. The computing system of claim 1, wherein the aggregation component is configured to obtain the aggregated user data from user profiles corresponding to the plurality of users.

3. The computing system of claim 1, wherein the user data comprises user work attribute data.

4. The computing system of claim 3, wherein the aggregation component comprises an active work identifier component configured to identify active work based on activity of the given user relative to the work, wherein the aggregation component aggregates the user work attribute data based on the identified active work.

5. The computing system of claim 3, wherein the portion of the organization graph visualized in the user interface display comprises the plurality of users, and the user interface display conflates the portion of the organization graph with the aggregated user work attribute data.

6. The computing system of claim 5, wherein the aggregated user work attribute data comprises a plurality of different work attributes within a particular work attribute category.

7. The computing system of claim 6, wherein the particular work attribute category comprises at least one of user skills, user work experience, user certifications, user education, projects, or subject matter areas.

8. The computing system of claim 6, wherein the user interface display includes a user input mechanism configured to detect a user interaction with the user interface display that selects the particular work attribute category from a plurality of work attribute categories.

9. The computing system of claim 6, wherein the user interface element comprises a plurality of aggregation metrics, each aggregation metric visually representing one of the user work attributes.

10. The computing system of claim 9, and further comprising a filter component, wherein the user interface element comprises a plurality of user input mechanisms each configured to detect user interaction with the user interface element, each user input mechanism comprising one of the aggregation metrics and being actuatable to select the user work attribute represented by the aggregation metric and to control the display system, using the filter component, to display a subset of the plurality of users based on the selected user work attribute.

11. The computing system of claim 10, wherein each user input mechanism is actuatable to control the display system to display the subset of the plurality of users, along with a set of users that are identified based on the selected user work attribute and are not identified as being related to the given user in the organization graph.

12. The computing system of claim 1, wherein the user interface display includes a user input mechanism visually representing a node in the organization graph that corresponds to the given user, the user input mechanism being actuatable to select the given user upon which display of the aggregated data is based.

13. The computing system of claim 1, wherein the aggregation component is configured to identify the plurality of users, by identifying a first node in the organization graph that corresponds to the given user and identifying descendent nodes in the organization graph, that descend from the first node and correspond to the plurality of users.

14. The computing system of claim 13, wherein the organization graph comprises a hierarchical organization chart having nodes arranged in a plurality of hierarchical levels, and wherein the aggregation component is configured to precompute the aggregate user data by upwardly traversing the plurality of hierarchical levels.

15. The computing system of claim 1, wherein the aggregation component comprises an indexing component configured to index, for the given user, the aggregated user data.

16. The computing system of claim 1, wherein the organization graph comprises a hierarchical organization chart having nodes arranged in hierarchical parent/child relationships, and wherein the aggregate data user interface display includes a hierarchical display depth user input mechanism that receives a user input that indicates a number of levels within the hierarchical organization chart for which to display aggregate user work attributes for the given user.

17. A computer-implemented method comprising:
identifying a given user;
aggregating user work attribute data, from a plurality of users, based on a relationship of the plurality of users to the given user in an organization graph, the organization graph representing users of an organization as nodes and connections between the nodes represent relationships between the users; and
generating an aggregate work attribute user interface display that visualizes at least a portion of the organization graph and displays a user interface element that represents the aggregated user data.

18. The computer-implemented method of claim 17, wherein the portion of the organization graph visualized in the user interface display comprises the plurality of users, and the aggregated user work attribute data comprises a plurality of different user work attributes within a particular work attribute category, and wherein generating the aggregate work attribute user interface display comprises:
displaying the user interface element with a set of aggregation metrics, each aggregation metric visually representing one of the user work attributes.

19. A computing system comprising:
a display system;
an organization graph component configured to access an organization graph that represents users of an organization as nodes and connections between the nodes represent relationships between the users; and
a data surfacing system configured to:
control the display system to generate a user interface display with a user selection user input mechanism and a work attribute selection user input mechanism;
detect a user interaction with the user selection user input mechanism that selects a user and a user interaction with the work attribute selection user input mechanism that selects a work attribute;
identify a first set of users that are associated with the selected work attribute and are related to the selected user in the organization graph and a second set of users that are associated with the selected work attribute and are not related to the selected user in the organization graph; and
control the display system to generate a user interface display element that represents the first and second sets of users.

20. The computing system of claim 19, wherein the user interface display element visually distinguishes the first and second sets of users, and the work attribute selection user input mechanism visualizes a plurality of aggregation metrics, each aggregation metric visually representing one of a plurality of different user work attributes.
